(19) United States
(12) Patent Application Publication
(10) Pub. No.: US 2010/0196784 A1
(43) Pub. Date: Aug. 5, 2010

(54) FUEL CELL, FUEL CELL METAL SEPARATOR, AND FUEL CELL MANUFACTURING METHOD

(76) Inventors: Kenji Kimura, Aichi-ken (JP); Jinhak Kim, Aichi-ken (JP); Junichi Shirahama, Aichi-ken (JP); Haruyuki Aono, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/598,939

(22) PCT Filed: May 1, 2008
(86) PCT No.: PCT/JP2008/058684

§ 371 Date: Apr. 19, 2010

(30) Foreign Application Priority Data
May 7, 2007 (JP) 2007-122244

(51) Int. Cl. H01M 8/10; B32B 37/02

(52) U.S. Cl. 429/483; 156/60; 156/150

(57) ABSTRACT

A fuel cell having a seal structure that exhibits excellent sealing properties and corrosion resistance. By providing a resin layer on at least a portion of an adhesion region where a metal separator contacts an adhesive, a fuel cell having a seal structure that exhibits excellent sealing properties and corrosion resistance can be provided.

### TECHNICAL FIELD

The present invention relates to a fuel cell, a fuel cell metal separator, and a method of manufacturing a fuel cell.

### BACKGROUND ART

Fuel cells, which generate electricity by converting chemical energy to electrical energy via an electrochemical reaction that uses, as raw materials, an oxidizing gas such as oxygen or air, and a reducing gas (a fuel gas) such as hydrogen or methane or a liquid fuel such as methanol are attracting considerable attention as one possible countermeasure to environmental problems and resource problems.

A unit fuel cell (unit cell) is formed by sandwiching a membrane electrode assembly (MEA), in which a fuel electrode (an anode catalyst layer) provided on one surface of an electrolyte membrane and an air electrode (a cathode catalyst layer) provided on the other surface are disposed facing one another across the electrolyte membrane, between separators such as metal separators. A plurality of these unit cells are stacked together to form a fuel cell stack. Fluid passages are formed in the separators, so that in the power generation region, fuel gas passages and oxidizing gas passages are formed in the surfaces opposing the MEA, and coolant passages are formed in the surfaces on the opposite side to the surfaces opposing the MEA, whereas in the non-power generation region, a fuel gas manifold, an oxidizing gas manifold and a coolant manifold are formed. The fuel gas flows from the fuel gas manifold through the fuel gas passages, the oxidizing gas flows from the oxidizing gas manifold through the oxidizing gas passages, and the coolant flows from the coolant manifold through the coolant passages. The fluid passages are sealed from the external environment by a sealing material such as an adhesive or a gasket.

During power generation using the fuel cell, if the raw material supplied to the fuel electrode is hydrogen gas and the raw material supplied to the air electrode is air, then at the fuel electrode, hydrogen ions and electrons are generated from the hydrogen gas. The electrons travel from an external terminal and through an external circuit, before reaching the air electrode. At the air electrode, the oxygen within the supplied air, the hydrogen ions that have passed through the electrolyte membrane, and the electrons that have traveled through the external circuit to reach the air electrode generate water. In this manner, chemical reactions occur at both the fuel electrode and the air electrode, and an electrical charge is generated, enabling the structure to function as an electric cell. Because the raw material gases and/or liquid fuels used for power generation are abundant, and the material discharged as a result of the power generation is water, this type of fuel cell is being widely investigated as a potential clean energy source.

In those cases where metal separators are used as the separators, as shown in the cross-sectional view of FIG. 7 that illustrates a portion of the peripheral edge of a conventional fuel cell stacked structure 60, generally, in order to reduce the electrical contact resistance between adjacent cells 62, a noble metal coating 68 is formed across the entire surface of a separator substrate 64 on the opposite side to the surface that opposes the MEA 66 (the MEA-opposing surface), whereas in order to reduce the electrical contact resistance between a separator 78 and the MEA 66, and suppress corrosion of the separator 78 caused by acidic components or the like within the raw material gases (namely, the fuel gas and the oxidizing gas) and the generated water, a gold coating 70a and a carbon coating 70b are formed as corrosion-resistant coatings across the entire surface of the MEA-opposing surface of the separator substrate 64. The separator 78 having these surface-treatment coatings such as the noble metal coating 68 and the corrosion-resistant coatings 70a and 70b formed thereon is sealed against a resin frame 74 with an adhesive layer 72 that employs an adhesive or the like. Furthermore, adjacent unit cells 62 are sealed using a gasket 76 or the like.

However, metal separators that that have been subjected to surface-treatment coating across the entire separator surface suffer from the problems outlined below. Generally, a noble metal coating is chemically inert with respect to adhesives, corrosion-resistant coatings and metal separator substrates, and because the coating relies mainly on close physical adhesion, it tends to suffer from weak adhesive strength, and is more likely to undergo detachment than the adhesion achieved between adhesives and metal separator substrates. As a result, if an adhesive is used as a sealing material, then the expansion and contraction and the like that occurs during fuel cell power generation may cause various problems, including:

(1) detachment of the adhesive from the noble metal coating,

(2) detachment of the noble metal coating from the separator substrate, and

(3) detachment of the corrosion-resistant coating from either the noble metal coating or the separator substrate.

Even if the initial sealing properties are satisfactory, if detachment occurs, then the sealing properties at the sealed portions can no longer be ensured, making it difficult to achieve sustained sealing properties. Further, if the corrosion-resistant coating inhibits curing of the adhesive, then achieving satisfactory initial sealing properties may also be problematic.

Accordingly, Patent Document 1 discloses a fuel cell sealing structure in which a metal separator has an uncoated portion, which is not surface-coated and in which the metal separator substrate is exposed, in a region that makes contact with an adhesive, enabling the adhesive to make direct contact with the metal separator substrate at this uncoated portion on the metal separator.

Further, Patent Document 2 discloses a fuel cell separator in which no adhesive layer is provided between a metal separator substrate having a resin layer (a corrosion-resistant layer) and a resin frame, and the separator substrate and the resin frame are bonded together directly by providing a rough surface layer on the surface of the substrate.

Furthermore, Patent Document 3 discloses formation of a metal separator adhesive layer using electrodeposition.

In a structure such as that disclosed in Patent Document 1, where an adhesive makes direct contact with the metal separator substrate at an uncoated portion on the metal separator, because no surface-treatment coating exists at the joint region, there is a possibility that corrosion may start at that joint region while it is still exposed.

Further, in a structure such as that disclosed in Patent Document 2, where a metal separator substrate and a resin frame are bonded together directly without any adhesive layer provided therebetween, the lack of an adhesive layer at the joint region increases the likelihood of detachment, meaning corrosion may start at that joint region when it is exposed.

Furthermore, even if an adhesive layer formed using the type of electrodeposition described in Patent Document 3 is used for bonding a metal separator having a noble metal coating to a resin frame, the types of detachment problems described above can still not be entirely resolved.

Patent Document 1: JP 2006-107862 A

Patent Document 2: JP 2002-190304 A

Patent Document 3: JP 2006-80026 A

### DISCLOSURE OF INVENTION

### Problems to be Solved by the Invention

The present invention provides a fuel cell having a seal structure that exhibits excellent sealing properties and corrosion resistance, a metal separator for the fuel cell, and a method of manufacturing the fuel cell.

### Means to Solve the Problems

The present invention provides a fuel cell comprising resin frames that oppose each other across a membrane electrode assembly disposed therebetween, and metal separators that oppose each other with the resin frames disposed therebetween, wherein the resin frames and the metal separators are sealed with an adhesive layer, and the metal separators are provided with a resin layer on at least a portion of an adhesion region where the metal separator contacts the adhesive layer.

Further, in the above fuel cell, the resin layer is preferably an electrodeposition layer.

Further, in the above fuel cell, the resin layer preferably comprises at least one of a polyimide-based resin and a polyamideimide-based resin.

Furthermore, in the above fuel cell, the metal separators are preferably provided with a resin layer across the entire surface of the adhesion region.

Further, in the above fuel cell, the thickness of the resin layer is preferably within a range from approximately 5 μm to approximately 30 μm.

Furthermore, in the above fuel cell, the adhesive strength between the resin layer, and the metal separator and the adhesive layer is preferably not less than approximately 0.25.

Moreover, the present invention also provides a fuel cell metal separator that is used for sandwiching resin frames that oppose each other across a membrane electrode assembly disposed therebetween, wherein the metal separator is provided with a resin layer on at least a portion of an adhesion region where the metal separator contacts an adhesive layer during sealing of the metal separator and the resin frames with the adhesive layer.

Further, in the above fuel cell metal separator, the resin layer is preferably an electrodeposition layer.

Further, in the above fuel cell metal separator, the resin layer preferably comprises at least one of a polyimide-based resin and a polyamideimide-based resin.

Furthermore, in the above fuel cell metal separator, the metal separator is preferably provided with a resin layer across the entire surface of the adhesion region.

Further, in the above fuel cell metal separator, the thickness of the resin layer is preferably within a range from approximately 5 μm to approximately 30 μm.

Moreover, the present invention also provides a method of manufacturing a fuel cell comprising resin frames that oppose each other across a membrane electrode assembly disposed therebetween, and metal separators that oppose each other with the resin frames disposed therebetween, the method comprising: forming a resin layer on at least a portion of an adhesion region of the metal separator where the metal separator is bonded to the resin frame, and adhering and sealing the resin layer on the metal separator and the resin frame with an adhesive layer.

Furthermore, in the above method of manufacturing a fuel cell, the resin layer is preferably formed by an electrodeposition method.

### Effect of the Invention

The present invention, by providing a resin layer on at least a portion of an adhesion region where a metal separator contacts an adhesive layer, is able to provide a fuel cell and a fuel cell separator having seal structures that exhibit excellent sealing properties and corrosion resistance. Furthermore, the present invention is also able to provide a method of manufacturing such a fuel cell.

### BRIEF DESCRIPTION OF THE DRAWINGS

FIG. 1 is a schematic side view illustrating one example of a fuel cell according to an embodiment of the present invention.

FIG. 2 is a schematic cross-sectional view illustrating one example of a MEA (membrane electrode assembly) in a fuel cell according to an embodiment of the present invention.

FIG. 3 is a schematic top view illustrating one example of a unit cell in a fuel cell according to an embodiment of the present invention.

FIG. 4 is an exploded schematic perspective view illustrating one example of a unit cell in a fuel cell according to an embodiment of the present invention.

FIG. 5 is a schematic cross-sectional view along the line A-A in FIG. 3 illustrating a unit cell in a fuel cell according to an embodiment of the present invention.

FIG. 6 is a schematic cross-sectional view illustrating one example of a stacked cell structure in a fuel cell according to an embodiment of the present invention.

FIG. 7 is a schematic cross-sectional view illustrating one example of a stacked cell structure in a conventional fuel cell.

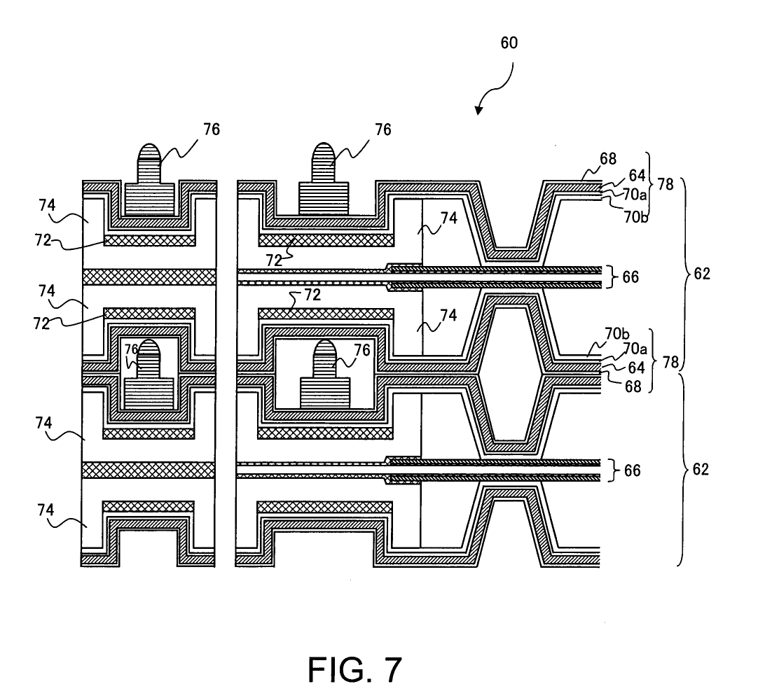

### DESCRIPTION OF THE REFERENCE SYMBOLS

10: Fuel cell
11: Electrolyte membrane
12, 15: Catalyst layer
13, 16: Diffusion layer
14: Fuel electrode (anode)
17: Air electrode (cathode)
18: Metal separator
19, 62: Unit cell
20: Terminal
21: Insulator
22: End plate
23: Fuel cell stack
24: Fastening member
25: Bolt and nut
26: Coolant passage (cooling water passage)
27: Fuel gas passage
28: Oxidizing gas passage
29: Coolant manifold
30: Fuel gas manifold
31: Oxidizing gas manifold
36, 74: Resin frame
38, 60: Stacked cell structure
40, 66: MEA
42, 68: Noble metal coating
44a, 70a: Corrosion-resistant coating (gold coating)
44b, 70b: Corrosion-resistant coating (carbon coating)
46, 49, 72: Adhesive layer
47: Metal separator substrate
48, 76: Gasket
50: Resin layer
51: Power generation region
52: Non-power generation region
64: Separator substrate
78: Separator

### BEST MODE FOR CARRYING OUT THE INVENTION

An embodiment of the present invention is described below. This embodiment is merely one example of implementing the present invention, and the present invention is in no way limited by this embodiment.

### <Fuel Cell Metal Separator and Fuel Cell>

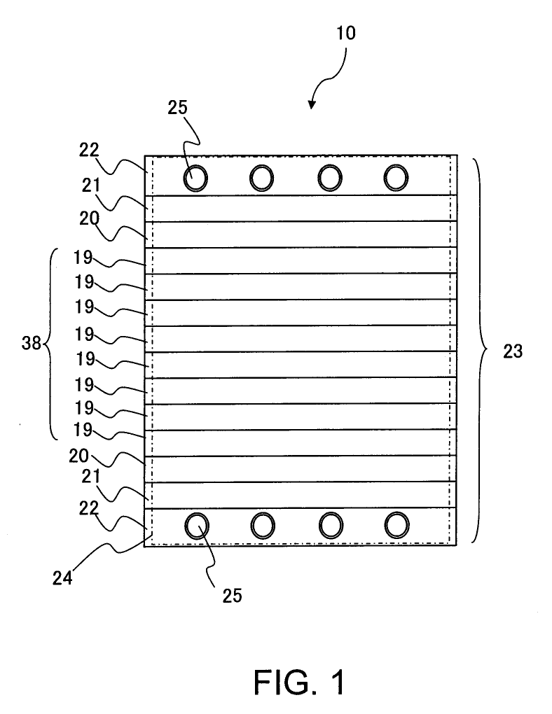

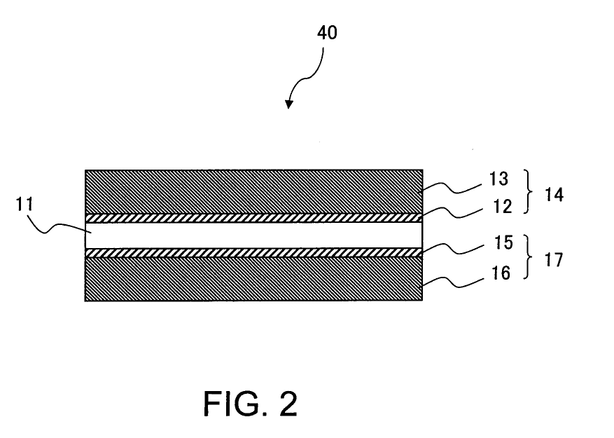

FIG. 1 illustrates a schematic side view of one example of a solid polymer electrolyte fuel cell 10 according to an embodiment of the present invention. Further, FIG. 2 illustrates a schematic cross-sectional view of one example of a MEA (membrane electrode assembly) in the fuel cell 10 according to this embodiment. Each unit cell 19 in FIG. 1 contains a stacked structure comprising an MEA 40 illustrated in FIG. 2 and a separator.

As illustrated in FIG. 2, the MEA 40 comprises an electrolyte membrane 11, a fuel electrode (anode) 14 comprising a catalyst layer 12 disposed on one surface of the electrolyte membrane 11, and an air electrode (cathode) 17 comprising a catalyst layer 15 disposed on the other surface of the electrolyte membrane 11. Gas diffusion layers 13 and 16 that are gas-permeable are provided between the catalyst layers 12 and 15 and the separators (which are not illustrated in FIG. 2), on the anode side and the cathode side respectively of the MEA.

A unit cell 19 is formed by stacking the MEA 40 and separators that are used to sandwich both outer surfaces of the diffusion layers 13 and 16, and as illustrated in FIG. 1, a plurality of these unit cells 19 are stacked to generate a stacked cell structure 38. A terminal 20, an insulator 21 and an end plate 22 are provided at each end of the stacked cell structure 38 in the stacking direction, the stacked cell structure 38 is clamped in the cell stacking direction, and fastening members (such as tension plates) 24 that extend in the cell stacking direction are secured to the outer surfaces of the stacked cell structure 38 using bolts and nuts 25 or the like, thus forming a fuel cell stack 23. There are no particular restrictions on the number of unit cells 19 stacked in the stacked cell structure 38, and any number of one or more is possible.

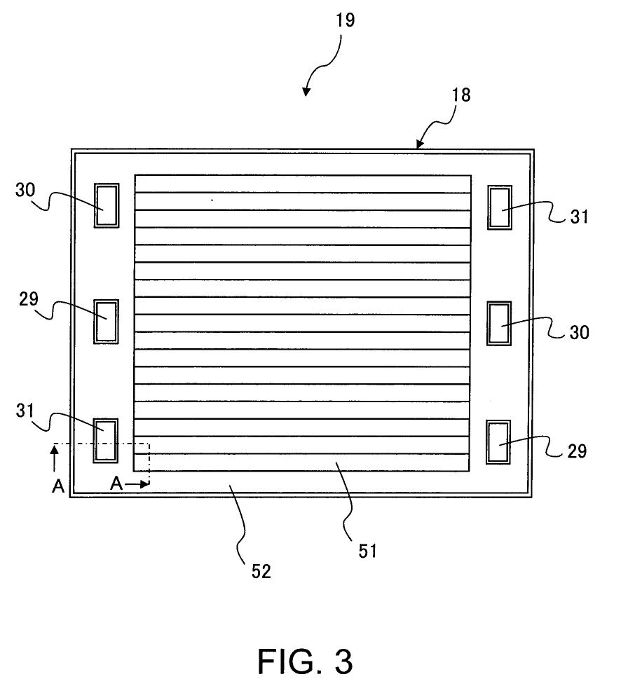

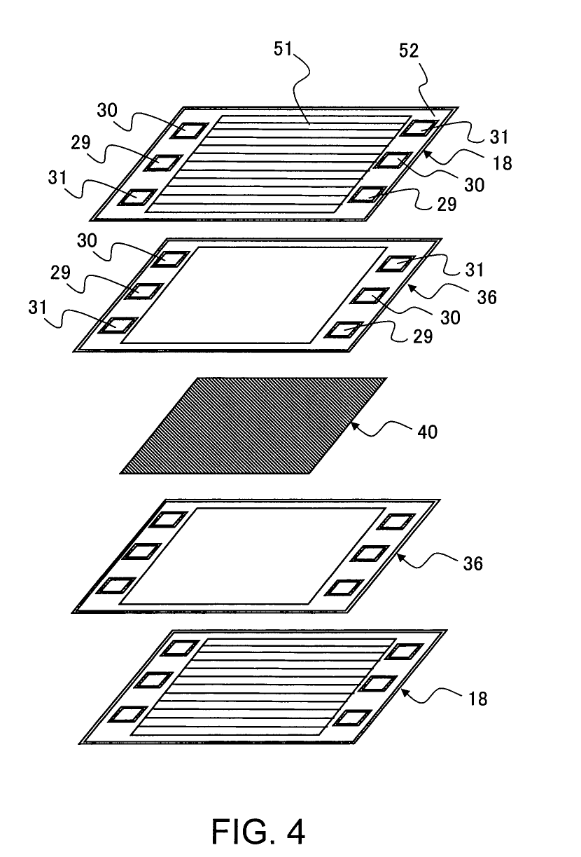

FIG. 3 illustrates a schematic top view of one example of a unit cell 19. The unit cell 19 has a power generation region 51 in the central portion of the cell, which generates electric power and inside of which are located the gas passages, the coolant passages and the electrodes, and a non-power generation region 52 which does not generate power and is provided around the periphery of the power generation region. The separator is a metal separator (hereafter referred to as “the metal separator”) 18. As is evident from the exploded schematic perspective view of the unit cell 19 illustrated in FIG. 4, in the unit cell 19, a frame-shaped resin frame 36 (in which the region corresponding with the power generation region 51 is hollow) is provided between the MEA 40 and each metal separator 18 in the non-power generation region 52, with the MEA 40 sandwiched between two resin frames 36, and the two resin frames 36 sandwiched between two metal separators 18. Fuel gas manifolds 30, oxidizing gas manifolds 31 and coolant manifolds 29 are formed in the non-power generation regions 52 of the metal separators 18 and the resin frames 36. The positions of the fuel gas manifolds 30, the oxidizing gas manifolds 31 and the coolant manifolds 29 within the non-power generation region 52 are not restricted to the positions shown in FIG. 3 and FIG. 4.

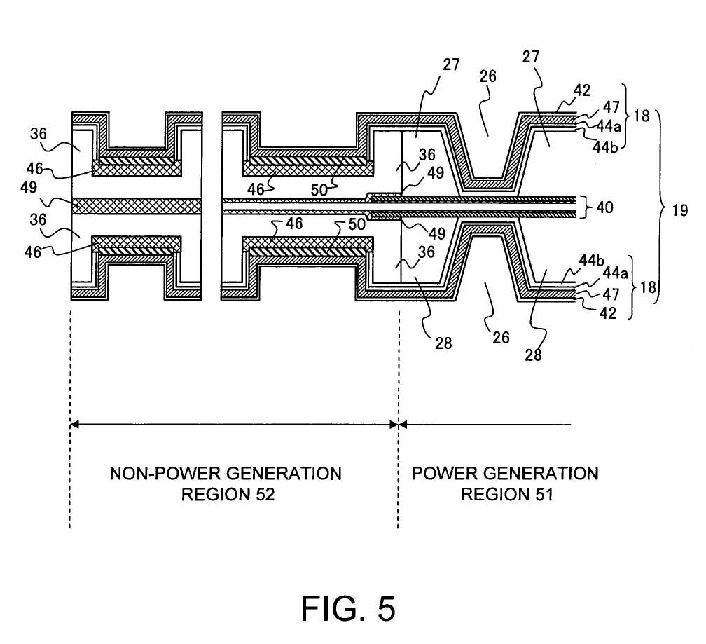

FIG. 5 is a schematic cross-sectional view along the line A-A in FIG. 3. In the power generation region 51, fuel gas passages 27 for supplying a fuel gas (typically hydrogen) to the anode side of the MEA 40, and oxidizing gas passages 28 for supplying an oxidizing gas (oxygen, typically air) to the cathode side of the MEA 40 are formed by the metal separators 18. Further, coolant passages 26 for circulating a coolant (typically cooling water) are also formed in the metal separators 18. The fuel gas manifolds 30 illustrated in FIG. 3 and FIG. 4 are connected to the fuel gas passages 27 illustrated in FIG. 5, the oxidizing gas manifolds 31 are connected to the oxidizing gas passages 28, and the coolant manifolds 29 are connected to the coolant passages 26. The manifolds 30, 31 and 29, and the fluid passages 27, 28 and 26 in the power generation region are respectively connected via connection passages not shown in the drawings, and the fluids also flow through these connection passages.

In the unit cell 19, a plurality of coolant passages 26, fuel gas passages 27 and oxidizing gas passages 28 are usually formed in parallel.

In the metal separator 18 according to the present embodiment, in order to reduce the electrical contact resistance between adjacent unit cells 19, a noble metal coating 42 is formed on the metal separator substrate 47, on the opposite surface to the surface opposing the MEA 40 (the MEA-opposing surface). Moreover, in order to reduce the electrical contact resistance between the separator 18 and the MEA 40, and suppress corrosion of the metal separator 18 caused by acidic components or the like within the raw material gases (namely, the fuel gas and the oxidizing gas) and the generated water, corrosion-resistant coatings 44a and 44b are formed on the MEA-opposing surface of the metal separator substrate 47. Of these surface treatment coatings, the corrosion-resistant coatings 44a and 44b are preferably also formed in the regions that constitute the connection passages of the metal separator substrate 47.

The area between a pair of resin frames 36 sandwiching the MEA 40 is sealed with an adhesive layer 49 that uses an adhesive or the like. On the other hand, the metal separator that has been surface-coated with the noble metal coating 42 and the corrosion-resistant coatings 44a and 44b is sealed against the resin frame 36 with an adhesive layer 46 that that uses an adhesive or the like. In at least a portion of the adhesion region where the metal separator 18 contacts the adhesive layer 46, the corrosion-resistant coatings 44a and 44b are not formed, and a resin layer 50 is formed instead. In other words, the resin layer 50 is provided on at least a portion of the adhesion region where the metal separator 18 contacts the adhesive layer 46. The metal separator 18 is preferably provided with the resin layer 50 across the entire surface of the adhesion region.

In this manner, by not forming the corrosion-resistant coatings 44a and 44b, but rather forming the resin layer 50, in the adhesion region where the metal separator 18 contacts the adhesive layer 46, the adhesion between the metal separator 18 and the resin frame 36 can be strengthened, reducing the likelihood of detachment caused by the expansion and contraction and the like that occur during fuel cell power generation. Accordingly, the initial sealing properties and the sustainability of the sealing properties can be better ensured. Furthermore, by providing the resin layer 50 on the metal separator 18, corrosion of the metal separator 18 can be suppressed even if a gap develops at the interface between the resin layer 50 and the adhesive layer 46. It is thought that this is because the adhesive strength between the adhesive layer 46 and the resin layer 50 is more powerful than the adhesive strength at each of the interfaces where the corrosion-resistant coatings 44a or 44b are bonded to the adhesive layer 46.

In each unit cell 19 of the fuel cell 10, if the unit cell is operated using hydrogen gas as the fuel gas supplied to the fuel electrode 14 and air as the oxidizing gas supplied to the air electrode 17, then at the catalyst layer 12 of the fuel electrode 14, hydrogen ions (H⁺) and electrons (e⁻) are generated from the hydrogen gas (H₂) via a chemical reaction (a hydrogen oxidation reaction) represented by the reaction equation shown below.

2H₂→4H⁺+4e⁻

The electrons (e⁻) travel from the diffusion layer 13, through an external circuit, and then through the diffusion layer 16 of the air electrode 17 before reaching the catalyst layer 15. At the catalyst layer 15, the oxygen (O₂) within the supplied air, the hydrogen ions (H⁺) that have passed through the electrolyte membrane 11, and the electrons (e⁻) that have traveled through the external circuit to reach the catalyst layer 15 generate water via a chemical reaction (an oxygen reduction reaction) represented by the reaction equation shown below.

4H⁺+O₂+4e⁻→2H₂O

In this manner, chemical reactions occur at both the fuel electrode 14 and the air electrode 17, thereby generating an electrical charge and enabling the structure to function as an electric cell. Because the component discharged from this series of reactions is water, a clean electric cell is achieved.

In the present embodiment, the material used for forming the metal separator substrate 47 may be stainless steel, aluminum or an alloy thereof, titanium or an alloy thereof, magnesium or an alloy thereof, copper or an alloy thereof, nickel or an alloy thereof, or steel or the like. The thickness of the metal separator substrate 47 is typically within a range from approximately 0.1 mm to approximately 0.2 mm. The surface of the metal separator substrate 47 is typically coated with gold or the like to reduce the contact resistance.

The noble metal coating 42 comprises gold or the like in order to reduce the contact resistance. The thickness of the noble metal coating 42 is typically several hundred nm.

The corrosion-resistant coatings 44a and 44b may be composed, for example, of a gold coating 44a and a carbon coating 44b. The thicknesses of the corrosion-resistant coatings 44a and 44b are typically approximately 100 nm for the gold coating 44a and approximately 30 μm for the carbon coating 44b.

The material used for forming the resin frames 36 may be a fluororesin or the like.

The adhesive layers 46 and 49 typically comprise an adhesive containing a resin such as a silicone resin, olefin resin, epoxy resin or acrylic resin. The adhesive layers are usually applied as a liquid, which is spread by pressing together the members on either side of the applied adhesive layer. Following application, the adhesive layers may be solidified by drying or heating.

There are no particular limitations on the resin layer 50, provided it is capable of ensuring favorable adhesive strength between the metal separator 18 and the adhesive layer 46, and typical examples include polyimide-based resins, polyamideimide-based resins and epoxy resins. Of these, polyimide-based resins and polyamideimide-based resins are preferred as they exhibit excellent adhesive strength. Further, as described below, a resin layer formed using an electrodeposition method is preferred, and a polyimide-based resin or a polyamideimide-based resin formed using an electrodeposition method is particularly desirable. The resin layer 50 may be either an insulating resin or a non-insulating resin.

The thickness of the resin layer 50 is typically within a range from approximately 5 μm to approximately 30 μm, and is preferably from approximately 15 μm to approximately 25 μm. If the thickness of the resin layer 50 is less than approximately 5 μm, then the thickness may lack uniformity, and partially uncoated areas may exist. This results in inadequate adhesive strength between the resin layer 50 and the metal separator 18 and the adhesive layer 46, which may cause a deterioration in the sealing properties, and particularly the sealing property sustainability. On the other hand, if the thickness of the resin layer 50 exceeds approximately 30 μm, then from a structural perspective, the MEA surface pressure may deteriorate, resulting in increased contact resistance, whereas from the perspective of the resin coating properties, the increased thickness may cause increased surface roughness (resulting in a deterioration in the gasket sealing properties).

The adhesive strength between the resin layer 50, and the metal separator 18 and the adhesive layer 46 is preferably not less than approximately 0.25. If the adhesive strength is less than approximately 0.25, then the adhesive strength between the resin layer 50, and the metal separator 18 and the adhesive layer 46 may be inadequate, causing a deterioration in the sealing properties, and particularly the sealing property sustainability.

The depth of the adhesive surface on the metal separator substrate 47 provided with the resin layer 50 is preferably adjusted to ensure a thickness for the adhesive layer 46 that is ideal for the gap between the metal separator substrate 47 and the resin frame 36. This ideal thickness for the adhesive layer 46 is typically approximately 50 μm. This ensures that an ideal level of adhesive strength can be achieved between the resin layer 50, and the metal separator 18 and the adhesive layer 46.

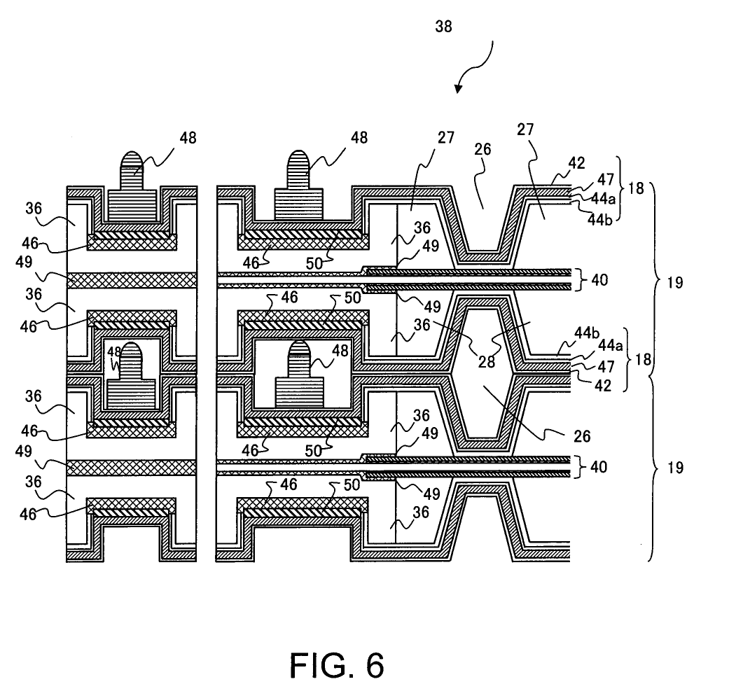

Between adjacent unit cells 19, sealing materials are disposed between neighboring metal separators 18, and these sealing materials seal each of the fluids that flow through the fuel gas manifold 30, the oxidizing gas manifold 31 and the coolant manifold 29 (namely, the fuel gas, the oxidizing gas and the coolant respectively), both from each other and from the external environment. Sealing materials are formed around the power generation region 51 (the region in which the fluid passages 26, 27 and 28 exist), and around the manifolds 29, 30 and 31 excluding the connection passages. These sealing materials may be either an adhesive or a gasket or the like, although gaskets are preferred as they enable ready disassembly of the unit cells 19. Gaskets may be formed from a silicone-based rubber, fluororubber, or EPDM (ethylene-propylene-diene rubber) or the like. FIG. 6 is a schematic cross-sectional view illustrating a portion of a stacked cell structure in which the areas between adjacent unit cells 19 have been sealed using gaskets 48. Of the sealed portions in FIG. 6, the portion between the metal separator 18 and the resin frame 36, and the portion between resin frames 36 are sealed using the adhesive layers 46 and 49 respectively, whereas the portion between adjacent unit cells 19 is sealed using the gaskets 48.

### <Method of Manufacturing Fuel Cell Metal Separator and Fuel Cell>

The fuel cell metal separator described above can be obtained using a method comprising a molding step of molding a metal separator substrate into a predetermined separator shape using a press method or etching method or the like, a resin layer formation step of forming a resin layer on at least a portion of an adhesion region of the metal separator where the metal separator is bonded to a resin frame, a noble metal coating formation step of forming a noble metal coating on a portion other than that where the resin layer has been formed, and a corrosion-resistant coating formation step of forming a corrosion-resistant coating on top of the noble metal coating. Moreover, a fuel cell unit cell and a fuel cell can be obtained by a method that further comprises an adhesion step of sealing the resin layer on the metal separator and the resin frame with an adhesive layer.

In the resin layer formation step, there are no particular restrictions on the method used in forming the resin layer 50, and possible methods include electrodeposition coating methods and the like. Of the various possible methods, formation of the resin layer 50 using an electrodeposition coating method is preferred as it enables the formation of a uniform and dense film. Forming the resin layer 50 using an electrodeposition coating method may reduce the likelihood of detachment between the metal separator 18 and the resin frame 36 caused by the expansion and contraction and the like that occur during fuel cell power generation. Here, the expression “electrodeposition coating method” describes a method in which a voltage is applied to the target item to be coated, and an electrodeposition coating material or the like is then layered onto the target item via an electrochemical process. Further, prior to subjecting the metal separator substrate 47 to electrodeposition coating, a chemical conversion treatment using FeOOH or the like may be performed as a pretreatment.

In the noble metal coating step, there are no particular restrictions on the method used in forming the noble metal coating 42 on the metal separator substrate 47, and for example, a noble metal plating treatment or noble metal sputtering treatment may be performed.

Furthermore, in the corrosion-resistant coating formation step, there are no particular restrictions on the methods used in forming the corrosion-resistant coatings 44a and 44b, and examples of methods that may be used include corrosion-resistant material plating treatments, corrosion-resistant material sputtering treatments, corrosion-resistant material spraying methods, and corrosion-resistant conductive film bonding methods.

All of these coatings can be formed by applying conventional surface treatment techniques, simply by masking the regions on the metal separator substrate 47 that are not to be coated. No special surface treatment techniques are required.

Thereafter, the unit cell 19 is formed by using conventional methods to perform an adhesion step of sealing the resin layer 50 of the metal separator 18, the resin frame 36 and the MEA 40 with an adhesive or the like. A predetermined number of these unit cells 19 are then stacked together to complete the production of a fuel cell.

In the method of manufacturing a fuel cell metal separator and the method of manufacturing a fuel cell according to the present invention, by forming a resin layer on at least a portion of the adhesion region where the metal separator contacts the adhesive layer, a fuel cell and a fuel cell separator having superior sealing properties and corrosion resistance can be manufactured.

The fuel cell at the present embodiment can be used as a small power source for portable equipment such as mobile phones and portable computers, or as a power source for automobiles or households.

### EXAMPLES

A more detailed description of specifics of the present invention is provided below based on an example and a comparative example, although the present invention is in no way limited by the examples presented below.

### Example 1

An SUS metal separator substrate (450 mm×200 mm×0.1 mm) is molded into a predetermined separator shape using a press method, the metal separator substrate is masked, and an electrodeposition method is used to form a polyamideimide film (film thickness: 20 μm) within an adhesion region. Subsequently, electroplating is used to form a gold plating (thickness: 0.1 μm) on the regions other than the adhesion region where the polyamideimide film had been formed. A carbon coating (thickness: 30 μm) is then formed on top of the gold coating on the same side of the substrate as the polyamideimide film, thus completing preparation of a surface-coated metal separator.

### Comparative Example 1

With the exception of not forming the polyamideimide film within the adhesion region, a surface-coated metal separator is prepared in the same manner as example 1.

The initial adhesive strength for example 1 is approximately 7 times that of comparative example 1, the adhesive strength for example 1 after 2,000 hours operation is approximately 4 times that of comparative example 1, and the adhesive strength for example 1 after 3,300 hours operation is approximately 4 times that of comparative example 1.

1. A fuel cell comprising resin frames that oppose each other across a membrane electrode assembly disposed therebetween, and metal separators that oppose each other with the resin frames disposed therebetween, wherein
the resin frames and the metal separators are sealed with an adhesive layer, and the metal separators are provided with a resin layer only on at least a portion of an adhesion region where the metal separator contacts the adhesive layer within a non-power generation region.

2. The fuel cell according to claim 1, wherein
the resin layer is an electrodeposition layer.

3. The fuel cell according to claim 1, wherein
the resin layer comprises at least one of a polyimide-based resin and a polyamideimide-based resin.

4. The fuel cell according to claim 1, wherein
the metal separators are provided with the resin layer across an entire surface of the adhesion region.

5. The fuel cell according to claim 1, wherein
a thickness of the resin layer is within a range from approximately 5 μm to approximately 30 μm.

6. The fuel cell according to claim 1, wherein
an adhesive strength between the resin layer, and the metal separator and the adhesive layer is preferably not less than approximately 0.25.

7. A fuel cell metal separator that is used for sandwiching resin frames that oppose each other across a membrane electrode assembly disposed therebetween, wherein
the metal separator is provided with a resin layer only on at least a portion of an adhesion region where the metal separator contacts an adhesive layer within a non-power generation region during sealing of the metal separator and the resin frames with the adhesive layer.

8. The fuel cell metal separator according to claim 7, wherein
the resin layer is an electrodeposition layer.

9. The fuel cell metal separator according to claim 7, wherein
the resin layer comprises at least one of a polyimide-based resin and a polyamideimide-based resin.

10. The fuel cell metal separator according to claim 7, wherein
the metal separator is provided with a resin layer across an entire surface of the adhesion region.

11. The fuel cell metal separator according to claim 7, wherein
a thickness of the resin layer is within a range from approximately 5 μm to approximately 30 μm.

12. A method of manufacturing a fuel cell comprising resin frames that oppose each other across a membrane electrode assembly disposed therebetween, and metal separators that oppose each other with the resin frames disposed therebetween, the method comprising:
forming a resin layer only on at least a portion of an adhesion region of the metal separator where the metal separator is bonded to the resin frame within a non-power generation region, and
adhering and sealing the resin layer on the metal separator and the resin frame with an adhesive layer.

13. The method of manufacturing a fuel cell according to claim 12, wherein
the resin layer is formed by an electrodeposition method.
